(19) United States
(12) Patent Application Publication
(10) Pub. No.: US 2004/0215631 A1
(43) Pub. Date: Oct. 28, 2004

(54) Method for handling data proportioning device and a proportioning device suited for performing the method

(76) Inventors: Uwe Mellenthin, Norderstedt (DE); Knut Paebst, Hamburg (DE); Ralf Dreyer, Henstedt-Ulzburg (DE); Peter Garzmann, Hamburg (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/646,850

(22) Filed: Aug. 22, 2003

(30) Foreign Application Priority Data
Aug. 30, 2002 (DE) 102 39 901.8

(51) Int. Cl. G06F 7/00

(52) U.S. Cl. 707/100

(57) ABSTRACT

A method for handling data of a proportioning device wherein the proportioning device, in the production process, is provided with at least one transponder into which data can be contactlessly stored by means of a writing device and from which data can be contactlessly read out by means of a reading device, production-related specific data of the proportioning device is stored, in the production process, into the transponder by means of a writing device and if applied, application-related specific data of the proportioning device is stored into the transponder by means of a writing device.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

Proportioning devices in the sense of the present application are manually or motor-operated pipettes or dispensers of a portable or stationary design, and automatic proportioning devices. During the manufacture of such proportioning devices, production-related data will result which, in particular, comprises the order, the individual product number, the product batch, and quality assurance data. Quality assurance data, in particular, include the data of an initial calibration by the manufacturer. This production-related data is conventionally recorded in documents accompanying the proportioning device and is archived by the manufacturer. In part, the data is only accessible by obtaining information from the manufacturer.

During application, application-related data will result such as inventory data or quality assurance data of the user. The quality assurance data of the user, in particular, includes the calibration data for a supervision of the measuring means. This data is conventionally recorded by the user in accompanying documents. In part, the data is affixed to the proportioning device on written labels

The disadvantage in former handling is that an access to the data and updating and supplementing it are intricate and the data needed will not always be readily available.

Accordingly, it is the object of the invention to provide a method simplifying the handling of data of a proportioning device and a device suited for performing the method.

### BRIEF DESCRIPTION OF THE INVENTION

In the inventive method for handling data of a proportioning device, the proportioning device, in the production process, is provided with at least one transponder into which data can be contactlessly stored by means of a writing device and from which data can be contactlessly read out by means of a reading device; production-related specific data of the proportioning device is stored, in the production process, into the transponder by means of a writing device, and if applied, application-related specific data of the proportioning device is stored into the transponder by means of a writing device.

The inventive proportioning device comprises a transponder into which production-related specific data and application-related specific data of the proportioning device can be contactlessly stored and from which such data can be con-tactlessly read out.

The invention allows to store the production-related and application-related specific data in the proportioning device. This ensures a manufacture and application of the proportioning device without accompanying documents, a simple possible way of updating and completing the data by means of a writing device and an easy and complete availability of data by means of a reading device. Further, a storage of the production-related and application-related specific data makes it easier to trace back the product (to the manufacturer, sales dept., users and fields of use, maintenance, and service). Another advantage is its ease of locating a sought proportioning device by contactlessly reading out specific data through packaging material, etc.

Appropriate transponders and writing and/or reading devices are available at reasonable prices. Suitable devices, in particular, include RFID (Radio Frequency Identification) systems which comprise a transponder in the form of a microchip with an aerial and a mobile or stationary writing and/or reading device with an aerial. These systems involve contactless data transmission based on an electromagnetic alternating field. Thus, RFID systems are available in different frequency ranges (kHz, MHz, GHz). The transponder further includes a software which manages data transfer and storage. This software is tailored to the application of the transponder. An active transponder having a power supply of its own (e.g. a battery) may be employed. According to a preferred aspect, the proportioning device is pro-vided with a passive transponder in which energy supply is effected by induction via the writing and/or reading device.

Suitable RFID systems, transponders, and writing and/or reading devices are made available, for example, by the companies MBBS SA, Rue de la Gare 5a, CH-2035 Corcelles/Switzerland (Product: MasterTrace™), PAV Card GmbH, Hamburger Strasse 6, 22952 Lütjensee/Germany (Product: “Scid M”), and Datatronic Kodiertechnik GmbH, A-2345 Brunn/Gebirge, Industriestrasse B16/BG5 (Product: Memor 2000 RFID”).

According to an aspect, a product component which is at the beginning of the assembly process is provided with the transponder to extensively store production-related data. Particularly if the proportioning device comprises a plurality of preassembled assembly modules composed of a plurality of product components a plurality of transponders may be employed which are associated to one assembly module each, preferably the product component of the respective assembly module that is at the beginning of the assembly process.

According to an aspect, the transponder is encapsulated in the proportioning device as a protection from mechanical damage or damage by aggressive liquids or gases. To this end, it may be disposed inside a casing of the proportioning device or may be injected into a plastic casing of the proportioning device.

According to an aspect, an article number and/or a serial number of the proportioning device and/or a production order number and/or a batch number and/or product modification data is/are stored into the transponder as production-related specific data.

According to an aspect, data of a initial calibration is stored into the transponder as production-related specific data. These comprise the following data as quality assurance data according to DIN or ISO:

Correctness

Precision

Date of initial calibration

Number of measuring place

Name/Number of a testing person

According to an aspect, sales data is stored into the transponder as application-related specific data. According to another aspect, the sales data comprises customer data (e.g. a customer number) and/or the date of sale.

According to an aspect, inventory data (e.g. the inventory number of the user) is stored into the transponder as application-related specific data. This simplifies the inventory data input for the proportioning devices.

According to an aspect, calibration data of the user is stored into the transponder as application-related specific data. These comprise the following data as quality insurance data for the supervision of measuring means within a certification:

Correctness

Precision

Date of calibration

Number of measuring place

Name/Number of a testing person

According to an aspect, usage data is stored as application-related specific data. For example, this can be data concerning the proportioned fluids of a contamination or decontamination.

According to an aspect, maintenance and/or repair data is stored into the transponder as application-related specific data. According to another aspect, the data comprises the date of last maintenance and/or repair and/or repair data (e.g. the repair reference number) which describe a defect and/or a component which was exchanged.

The production-related and/or application-related data may be stored to be fully or partially invariable and/or variable into the transponder. According to a preferred aspect, the production-related data are stored to be fully or partially invariable into the transponder because there is no regular demand now to vary or update them and, hence, this allows to secure the data. The same applies to sales data. According to an aspect, the application specific data is stored to be fully or partially variable into the transponder because an access is regularly required to the most actual data here and this saves memory space. Basically, however, it is also possible to store all of the data in an invariable way to comprehensively document all of the data as far as is admitted by the storage capacity. Transponders having a storage capacity of from 256 bits to 1 kByte are currently available.

According to an aspect, the production-related specific data stored in the transponder are read out fully or partially in the production process and/or during application and/or the application-related specific data stored in the transponder are read out fully or partially during application, by means of a reading device. All of the data which were stored will be available both in the production process and during application.

Examples will now be given for production-related and application-related data which can be provided to be stored in the proportioning device within the scope of the invention:

1. Production-related data

Article number

Manufacturer's order number

Individual works number of the device

Quality data

Time of calibration

Product modification data

2. Sales data

Customer's number

Date of sale

3. Servicing data

Guarantee data

Repair documentation (time, components)

Calibration data

Date of next calibration (to be called by the user)

4. User's application-related data

Specific calibration by the user

User assignment (person, section, cost centre, etc.)

Inventory number and data of life cycle supervision

Supervision of measuring means within certification (time, values measured, date of next calibration)

Usage data (e.g. when used in high-safety and/or radioactive areas; data of contamination or decontamination).

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

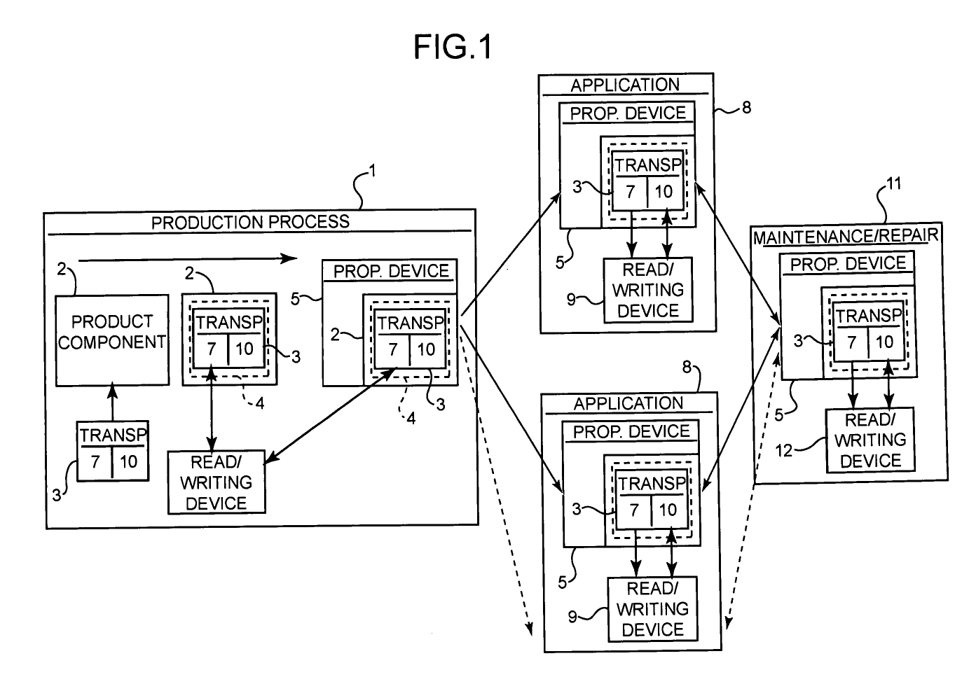

FIG. 1 is a schematic block diagram of the method for handling data of a proportioning device.

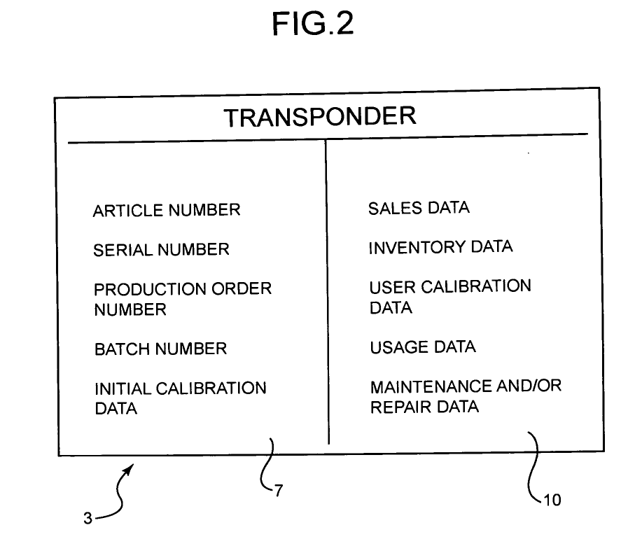

FIG. 2 is a schematic view showing the storage of data in a transponder.

As shown in FIG. 1, in a production process 1, product components 2 are provided with transponders 3. The transponders 3 are arranged within an encapsulation 4. The product components 2 are integrated in proportioning devices 5.

In the production process 1, production-related specifc data is contactlessly stored by means of a read-writing device 6 into the transponders 3. This production-related data is stored to be fully or partially invariable into a memory area 7 of the transponders 3.

Examples for production-related specific data stored in the transponders 3 are shown in FIG. 2.

During the production process 1, production related specific data stored in the transponders 3 are read out fully or partially by means of the read-writing device 6.

The proportioning devices 5 resulting from the production process 1 are transferred to numerous applications 8. During applications 8, application-related specific data of proportioning devices 5 is stored into the transponders 3 by means of further read-writing devices 9.

The application related specific data is stored to be fully or partially variable into a further memory area 10 of the transponders 3. Examples for application-related specific data are shown in FIG. 2.

During application data stored in the memory areas 7 and/or 10 of the transponders 3 is read out fully or partially by means of the read-writing devices 9.

In case of maintenance and/or repair 11 during application 1 of proportioning devices 5 maintenance and/or repair data is stored into the transponders 3 as application-related specific data by means of read-writing device 12. During maintenance and repair 11 the data stored in the transponders 3 is read out fully or partially by means of read-writing device 12.

The above Examples and disclosure are intended to be illustrative and not exhaustive. These examples and description will suggest many variations and alternatives to one of ordinary skill in this art. All these alternative and variations are intended to be included within the scope of the attached claims. Those familiar with the art may recognize other equivalents to the specific embodiments described herein which equivalents are also intended to be encompassed by the claims attached hereto

What is claimed is:

1. A method for handling data of a proportioning device wherein
the proportioning device, in the production process, is provided with at least one transponder into which data can be contactlessly stored by means of a writing device and from which data can be contactlessly read out by means of a reading device,
production-related specific data of the proportioning device is stored, in the production process, into the transponder by means of a writing device, and
if applied, application-related specific data of the proportioning device is stored into the transponder by means of a writing device.

2. The method as claimed in claim 1 wherein the proportioning device is provided with a passive transponder.

3. The method as claimed in claim 1 wherein a product component which is at the beginning of the assembly process is provided with the transponder.

4. The method as claimed in claim 1 wherein the transponder is encapsulated in the proportioning device.

5. The method as claimed in claim 1 wherein an article number and/or a serial number of the proportioning device and/or a production order number and/or a batch number is/are stored into the transponder as production-related specific data.

6. The method as claimed in claim 1 wherein data of an initial calibration is stored into the transponder as production-related specific data.

7. The method as claimed in claim 1 wherein sales data is stored into the transponder as application-related specific data.

8. The method as claimed in claim 1 wherein inventory data of the user is stored into the transponder as application-related specific data.

9. The method as claimed in claim 1 wherein calibration data of the user is stored into the transponder as application-related specific data.

10. The method as claimed in claim 1 wherein usage data is stored into the transponder as application-related specific data.

11. The method as claimed in claim 1 wherein maintenance and/or repair data is stored into the transponder as application-related specific data.

12. The method as claimed in claim 1 wherein the production-related specific data is stored to be fully or partially invariable into the transponder.

13. The method as claimed in claim 1 wherein the application-related specific data is stored to be fully or partially variable into the transponder.

14. The method as claimed in claim 1 wherein the production-related specific data stored in the transponder are read out fully or partially in the production process and/or during application and/or the application-related specific data stored in the transponder are read out fully or partially during application, by means of a reading device.

15. A proportioning device suited for performing the method as claimed in claim 1, with a transponder into which production-related specific data and application-related specific data of the proportioning device can be stored and from which said data can be read out.

16. The proportioning device as claimed in claim 15 wherein the transponder is a passive transponder.

17. The proportioning device as claimed in claim 15 wherein the transponder is encapsulated in a casing of the proportioning device.

18. The proportioning device as claimed in claim 15 wherein the transponder is disposed inside the casing of the proportioning device or is injected into the plastic casing of the proportioning device.

19. The proportioning device as claimed in claim 15 wherein the production-related specific data can be stored to be fully or partially invariable in the transponder.

20. The proportioning device as claimed in claim 15 wherein the application-related specific data can be stored to be fully or partially variable in the transponder.
